(19) United States
(12) Patent Application Publication
(10) Pub. No.: US 2011/0219415 A1
(43) Pub. Date: Sep. 8, 2011

(54) METHOD AND DEVICE FOR RECEIVING BROADCASTING PROGRAM

(76) Inventors: Young Kwon Hahm, Daejeon (KR); Yun Jeong Song, Daejeon (KR); Soo In Lee, Daejeon (KR)

(21) Appl. No.: 13/127,644

(22) PCT Filed: Nov. 4, 2009
(86) PCT No.: PCT/KR2009/006466

§ 371 Date: May 4, 2011

(30) Foreign Application Priority Data
Nov. 4, 2008 (KR) 10-2008-0109091

(51) Int. Cl. H04N 7/173

(52) U.S. Cl. 725/109; 725/131

(57) ABSTRACT

Provided is a broadcasting receiving method and device. The method detects the time of a televised broadcasting program, and provides the broadcasting program to the user from the start thereof. More specifically, the method requests transmission of the broadcasting program before a first time through the second network at the first time of the broadcasting program before a first time through the second network at the first time of the broadcasting program received through the first network, and stores the broadcasting program received through the first network at the first time. The broadcasting program, which was broadcasted before the first time, received through the second network from the first time to the second time is displayed and the stored broadcasting program after the second time is displayed.

### TECHNICAL FIELD

The present invention relates to a broadcasting receiving method and device, and in particular, it relates to a method and device for allowing a viewer to watch an already-begun broadcasting program from the start.

### BACKGROUND ART

A user watching a bMethod and device for receiving broadcasting program-roadcasting program changes broadcasting channels, fixes on one after finding a desired program, and views the corresponding broadcasting program. However, when the user determines that a broadcasting program is interesting and desires to watch it from the start, existing techniques cannot support this kind of service.

Regarding the methods for viewing the full program from its start, the user would have had to read the broadcasting schedule in advance, wait for the desired program, and then watch it, or the user would have had to reserve and record the desired program by using a personal video recorder (PVR) function and watch it. In addition, there is a service such as video on demand (VOD) for allowing the user to use desired contents at a desired time according to the user's request other than receiving the program through the broadcasting or the cable TV in the one-way manner. However, this VOD service becomes a major cause of applying an overload to the communication network since it consecutively uses video information through the communication network.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a broadcasting receiving method and device for allowing viewing of a broadcast program from the start while searching TV channels through a familiar method.

### Solution to Problem

An exemplary embodiment of the present invention provides a method for receiving a broadcasting program from a broadcasting transmitter or a streaming server including: receiving a provision request of a predetermined service at a time of a first broadcasting program transmitted by the broadcasting transmitter; checking an address of the streaming server from additional data included in the first broadcasting program according to the received provision request; requesting a second broadcasting program from a streaming server corresponding to the checked address, and checking a connection point which is location information for connecting the first broadcasting program and the second broadcasting program and is corresponding to the time when the provision request is inputted; and displaying the first broadcasting program or the second broadcasting program based on the location information.

Another embodiment of the present invention provides a method for receiving a broadcasting program through a first network and a second network including: requesting transmission of the broadcasting program before a first time through the second network at the first time of the broadcasting program received through the first network; storing the broadcasting program received through the first network at the first time; displaying the broadcasting program received through the second network from the first time to the second time; and displaying the stored broadcasting program after the second time.

Another embodiment of the present invention provides a device for receiving a broadcasting program from a broadcasting transmitter or a streaming server including: a switch for performing a switching operation to receive a first broadcasting program from the broadcasting transmitter or to store the first broadcasting program; a program storage unit for storing the first broadcasting program broadcasted from the broadcasting transmitter from a time; a controller for checking a connection point which is location information of the first broadcasting program and corresponds to the time, and controlling the first broadcasting program and the second broadcasting program to be connected to the connection point; and a display for displaying the first broadcasting program or the second broadcasting program.

### Advantageous Effects of Invention

According to the present invention, the broadcast program that is already started and progressed can be provided to the user from the start. Further, communication channel usage can be reduced compared to the VOD, and the user can use the service by searching the TV channel through a familiar method.

### BRIEF DESCRIPTION OF DRAWINGS

FIG. 1 shows a configuration diagram of a broadcasting watching device according to an exemplary embodiment of the present invention.

FIG. 2 shows a configuration diagram of a controller according to an exemplary embodiment of the present invention.

FIG. 3 shows a flowchart of a broadcasting watching method according to an exemplary embodiment of the present invention.

FIG. 4 shows storage and display contents with respect to time according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements

A broadcasting watching method and device according to an exemplary embodiment of the present invention will now be described with reference to accompanying drawings.

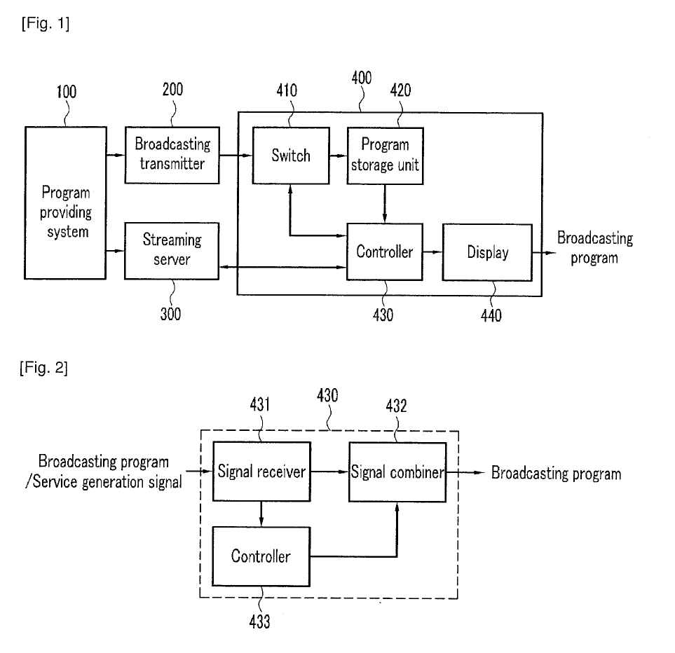

FIG. 1 shows a configuration diagram of a broadcasting system according to an exemplary embodiment of the present invention.

As shown in FIG. 1, the broadcasting system includes a broadcasting transmitter 200, a streaming server 300, and a broadcasting receiver 400.

The broadcasting transmitter 200 outputs a broadcasting program to be provided to the user by a program providing system (or a program provider) 100. Here, in order to display a notice that a function for watching the currently televised broadcast program from the start is available through the screen, additional data for notifying that it is a broadcasting program for providing a predetermined service are included in the broadcasting program and are then broadcast. Here, the predetermined service represents a service such as “View from the start,” but it is not limited thereto.

The streaming server 300 is provided on the communication network so as to provide the broadcasting program transmitted by the broadcasting transmitter 200 to the user through the communication network. The user can receive a service for viewing the program transmitted and broadcast by the broadcasting transmitter 200 through streaming server 300 from the start.

The broadcasting receiver 400 receives the broadcasting program from the broadcasting transmitter 200 or the streaming server 300, and includes a switch 410, a program storage unit 420, a controller 430, and a display 440.

The switch 410 receives a signal (e.g., view from the start) generated by the user's request, and switches the currently televised broadcasting program to one of the program storage unit 420 or the controller 430.

The program storage unit 420 stores the broadcasting program transmitted from the broadcasting network from a predetermined time. Here, the predetermined time represents the time when the user selects the service of “View from the start” and may be called a first time.

The controller 430 receives the broadcasting programs from the broadcasting network and the communication network at regular times, and decodes it and controls one of the broadcasting programs desired by the user to be selected at a desired time. For this purpose, the controller 430 includes a signal receiver 431, a signal combiner 432, and a controller 433 as shown in FIG. 2.

FIG. 2 shows a configuration diagram of a controller according to an exemplary embodiment of the present invention.

First, the signal receiver 431 receives the broadcasting program transmitted by the broadcasting transmitter 200 and stored in the program storage unit 420 or the broadcasting program transmitted by the streaming server 300. The signal receiver 431 extracts the additional data included in the broadcasting program and transmits the same to the controller 433. Also, when the user selects the function of “View from the start,” the signal receiver 431 receives this signal to check the generation time of the signal.

The signal combiner 432 smoothly connects the broadcasting program transmitted by the streaming server 300 and the broadcasting program stored in the program storage unit 420 based on connection time information provided by the controller 433. Here, connection time information represents information on the time when the user selected “View from the start.”

The controller 433 checks the address of the streaming server in the additional data provided by the signal receiver 431 to request the broadcasting program from the streaming server. Also, the controller 433 generates connection time information and transmits it so that the signal combiner 432 may connect the broadcasting programs.

The display 440 of FIG. 1 displays one of the broadcasting program transmitted through the broadcasting network selected by the controller 430 or the broadcasting program provided through the communication network to the user.

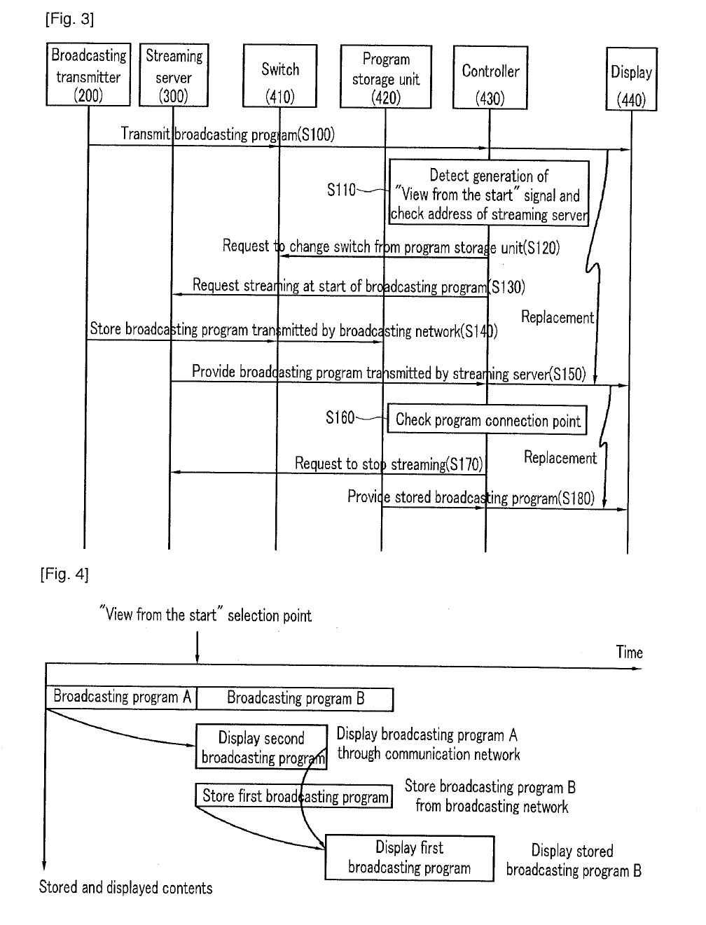

A method for storing and displaying a broadcasting program with respect to time by using the configuration of a broadcasting system according to an exemplary embodiment of the present invention will now be described with reference to FIG. 3 and FIG. 4.

FIG. 3 shows a flowchart of a broadcasting watching method according to an exemplary embodiment of the present invention, and FIG. 4 shows storage and display contents with respect to time according to an exemplary embodiment of the present invention.

As shown in FIG. 3 and FIG. 4, the program output by the broadcasting transmitter 200 includes additional data in the broadcasting program and outputs them in order to display provision of the “View from the start” function on the receiving screen (S100). Here, the additional data includes information on existence status of the “View from the start” function selectable by the user by using a device such as a remote controller, the same broadcasting program providing a streaming server, and an address of the program.

When the user selects the “View from the start” function while searching the channel in order to watch the broadcasting program supporting the “View from the start” function, the controller 430 of the broadcasting receiver 400 senses that the corresponding signal has been generated. The controller 430 checks the address of the streaming server included in the additional data of the broadcasting program (S110). In this instance, the method for the controller 430 to detect generation of the signal for indicating that the “View from the start” function is selected is well known to a person skilled in the art, and no corresponding detailed description will be provided in the exemplary embodiment of the present invention.

The controller 430 requests the switch 410 to control the currently televised broadcasting program to be stored in the program storage unit 420 from the time when the “View from the start” signal is received (S120). Through this process, the switch 410 is switched to store the broadcasting program transmitted by the broadcasting transmitter 200 in the program storage unit 420. The controller 430 requests the streaming server 300 corresponding to the address of the streaming server checked in S110 to stream the currently televised broadcasting program from the start (S130).

That is, the controller 430 checks the address of the streaming server 300 located in the communication network with the same program as the currently televised broadcasting program through the additional data of the broadcasting program (S110), and accesses the streaming server 300 to request provision of the streaming service of the corresponding program (S130). When the controller 430 requests the streaming server 300 to stream the broadcasting program, the broadcasting program transmitted by the broadcasting transmitter 200 is stored in the program storage unit 420 (S140). Simultaneously, the signal combiner 432 of the controller 430 transmits the broadcasting program contents from the streaming server 300 during the period from the time of the start of the broadcasting program to the time when the user selects the “View from the start” to the display 440 (S150) to display them to the user.

While receiving the broadcasting program from the streaming server 300, the controller 430 simultaneously checks the program connection point for receiving the broadcasting program through the broadcasting network (S160). That is, the controller 430 senses the location information of the televised broadcasting program when the user performs the “View from the start” function.

The controller 430 finds the location of “View from the start” point in the streamed program from the communication network, and stops the streaming service (broadcasting program A or second broadcasting program in FIG. 4) from the communication network (S170). The controller 430 controls the stored program from the broadcasting network to be smoothly connected with streamed program and displayed after the strop of streaming broadcasting (broadcasting program B or first broadcasting program in FIG. 4) (S180).

In order to detect the accurate location of the “View from the start” selection point, a time stamp of the protocol such as the MPEG-2 TS (Transport Stream) of the broadcasting program can be used, but the exemplary embodiment of the present invention is not limited thereto. Also, the method for finding the location by using the time stamp is well known to a person skilled in the art, and no detailed description thereof will be provided in the exemplary embodiment of the present invention.

The streaming server 300 encapsulates the broadcasting program including timing information used in the broadcasting network by a protocol appropriate for the communication channel and then transmits it so that the receiver 400 may accurately find the “View from the start” selection point from the broadcasting program received from the communication network. For example, when the MPEG-2 TS is used in the broadcasting program, the streaming server 300 also encapsulates the program including the MPEG-2 TS by a protocol appropriate for the communication channel and then transmits it.

Accordingly, the user can receive the televised broadcasting program from the start by using the broadcasting program through the communication network and the broadcasting network, and the usage of the communication channels causing the overload of the communication network can be reduced.

As shown in the above, according to the embodiments of the present invention, the time of a televised broadcasting program can be detected and the broadcasting program to the user from the start thereof is provided. Therefore, in a like manner of using a personal video recorder (PVR), the user can use the service for allowing the user to view the currently televised broadcasting program from the start while searching the TV channels through familiar methods without reserved recording of the broadcasting program. Further, since usage of communication channels can be reduced compared to the VOD, the communication load can be reduced.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for receiving a broadcasting program from a broadcasting transmitter or a streaming server, comprising:
receiving a provision request of a predetermined service at a time of a first broadcasting program transmitted by the broadcasting transmitter;
checking an address of the streaming server from additional data included in the first broadcasting program according to the received provision request;
requesting a second broadcasting program from a streaming server corresponding to the checked address, and checking a connection point which is location information for connecting the first broadcasting program and the second broadcasting program and is corresponding to the time when the provision request is inputted; and
displaying the first broadcasting program or the second broadcasting program based on the location information.

2. The method of claim 1, wherein
the checking an address of the streaming server includes storing the first broadcasting program transmitted by the broadcasting transmitter after the time in a program storage unit.

3. The method of claim 1, wherein
the second broadcasting program corresponds to the first broadcasting program, and is transmitted through a streaming service.

4. The method of claim 2, wherein
the displaying includes:
displaying the second broadcasting program;
stopping the displaying of the second broadcasting program and requesting transmission of the second broadcasting program from the streaming server when a location of the second broadcasting program corresponds to the location information; and
displaying the stored first broadcasting program.

5. A method for receiving a broadcasting program through a first network and a second network, comprising:
requesting transmission of the broadcasting program before a first time through the second network at the first time of the broadcasting program received through the first network;
storing the broadcasting program received through the first network at the first time;
displaying the broadcasting program received through the second network from the first time to the second time; and
displaying the stored broadcasting program after the second time.

6. The method of claim 5, wherein
the first network is a broadcasting network, and the second network is a communication network.

7. The method of claim 5, wherein
the broadcasting program display from the first time to the second time is provided through a streaming service.

8. A device for receiving a broadcasting program from a broadcasting transmitter or a streaming server, comprising:
a switch for performing a switching operation to receive a first broadcasting program from the broadcasting transmitter or to store the first broadcasting program;
a program storage unit for storing the first broadcasting program broadcasted from the broadcasting transmitter from a time;
a controller for checking a connection point which is location information of the first broadcasting program and corresponds to the time, and controlling the first broadcasting program and the second broadcasting program to be connected to the connection point; and
a display for displaying the first broadcasting program or the second broadcasting program.

9. The device of claim 8, wherein
the controller includes:
a signal receiver for receiving one of the first broadcasting program and the second broadcasting program, and extracting additional data in the broadcasting program;
a controller for checking an address of the streaming server based on the additional data to request a broadcasting program, and generating connection time information corresponding to the connection point so as to connect the first broadcasting program and the second broadcasting program; and
a signal combiner for connecting the first broadcasting program stored in the program storage unit and the second broadcasting program provided from the streaming server based on the connection time information, and outputting a connected program.

10. The device of claim 8, wherein
the additional data include an address of the streaming server and service providing function information.

11. The device of claim 9, wherein
the first broadcasting program corresponds to the second broadcasting program.
